(19) United States
(12) Patent Application Publication
(10) Pub. No.: US 2015/0262777 A1
(43) Pub. Date: Sep. 17, 2015

(54) ELECTROMAGNETIC RELAY

(71) Applicant: OMRON Corporation, Kyoto-shi (JP)

(72) Inventors: Tetsuro Tsurusu, Osaka (JP); Masayuki Noda, Osaka (JP); Tetsuya Minobe, Shiga (JP); Shuichi Itoda, Kyoto (JP)

(73) Assignee: OMRON CORPORATION, Kyoto-shi (JP)

(21) Appl. No.: 14/643,984

(22) Filed: Mar. 10, 2015

(30) Foreign Application Priority Data
Mar. 14, 2014 (JP) 2014-052065

(51) Int. Cl. H01H 51/06; H01H 33/18; H01H 50/12

(52) U.S. Cl. CPC H01H 51/06; H01H 50/12; H01H 33/182

(57) ABSTRACT

An electromagnetic relay has a base, a first stationary contact terminal mounted on the base, and having a first stationary contact mounted thereon, a first movable contact plate having a first movable contact mounted thereon, an electromagnet unit mounted on the base that moves the first movable contact plate to make or break a contact between the first stationary contact and the first movable contact, and a permanent magnet mounted on the base so as to extend an arcing generated between the first stationary contact and the first movable contact toward the base.

### BACKGROUND

1. Field of the Invention

The present invention relates to an electromagnetic relay and, more particularly, to an electromagnetic relay in which arcing is effectively extinguished.

2. Related Art

Conventionally, there has been disclosed an electromagnetic relay which comprises a pair of first and second stationary contacts opposing to each other through a first gap, a first movable contact provided between the first and second stationary contacts, a pair of third and fourth stationary contacts opposing to each other through a second gap, a second movable contact provided between the third and fourth stationary contacts, a permanent magnet for generating a magnetic flux extending in the opposing direction in the first and second gaps, and a driving section for driving the first and second movable contacts between the first and second stationary contacts and between the third and fourth stationary contacts, respectively, wherein the first and second movable contacts are kept in contact with the second and fourth stationary contacts, respectively, when the driving section is de-energized, and the first and second movable contacts are brought into contact with the first and third stationary contacts, respectively, when the driving section is energized (See Patent Document 1).

To extinguish the arcing, as shown in FIG. 1 of the Patent Document 1, the electromagnetic relay has a pair of permanent magnets. The magnets are arranged so that the arcing generated between the movable contact and the stationary contacts is pulled toward the inner surface of the housing not shown and thereby extinguished, with an aid of the force generated along the magnetic field lines from the permanent magnets and the electric current flow, according to Fleming's left-hand rule.

Patent Document 1: JP 2012-142195 A

### SUMMARY

In a conventional electromagnetic relay, because the distance between the contacts (movable contact and the stationary contacts) and the inner surface of the housing may be short, the arcing may be unable to be pulled out sufficiently, which may fail to extinguish the arcing effectively.

One or more embodiments of the present invention provides an electromagnetic relay in which arcing is effectively extinguished.

One or more embodiments of the invention provides an electromagnetic relay comprising a base, a first stationary contact terminal having a first stationary contact mounted thereon, the first stationary contact terminal being mounted on the base, a first movable contact plate having a first movable contact mounted on the first movable contact plate, an electromagnet unit mounted on the base which moves the first movable contact plate to make or break a contact between the first stationary contact and the first movable contact, and a permanent magnet mounted on the base so as to extend an arcing to be generated between the first stationary contact and the first movable contact toward the base.

Accordingly, the generated arcing is extended toward the base, which allows the arcing to be extinguished. Typically, the base is thick and therefore has a large heat capacity and therefore the arcing is effectively extinguished, which results in a durable electromagnetic relay.

In one or more embodiments of the invention, the base has a concaved portion provided at a portion toward which the arcing is extended.

Accordingly, the arcing is extended to the bottom of the concaved portion, which extinguishes the arcing effectively.

In one or more embodiments of the invention, the concaved portion has a groove having a bottom surface and an opening, the bottom surface having a width that is greater than a width of the opening.

Accordingly, the arcing is further extended within the groove, which extinguishes the arcing effectively.

In one or more embodiments of the invention, the concaved portion has a slot extending through the base.

Accordingly, the arcing is furthermore extended through the slot, which extinguishes the arcing effectively.

In one or more embodiments of the invention, the electromagnetic relay further comprises a second stationary contact terminal with a second stationary contact mounted thereon, the second stationary contact terminal being positioned so that the first and second stationary contacts oppose to each other through the first movable contact, which allows the first movable contact to make and break contact with the first and second stationary contacts alternately.

Accordingly, the arcing which may be generated at the making and breaking contact between the movable and the opposing stationary contacts is extinguished effectively.

In one or more embodiments of the invention, the concaved portion has at least one transverse groove defined therein between the first and second stationary contact terminals.

Accordingly, the arcing is further extended within the transverse groove, which extinguishes the arcing effectively.

In one or more embodiments of the invention, the electromagnetic relay comprises third and fourth stationary contact terminals having third and fourth stationary contacts mounted thereon, respectively, the third and fourth stationary contact terminals being positioned so that the third and fourth stationary contacts oppose to each other, and a second movable contact plate, the second movable contact plate having a second movable contact mounted on, the second movable contact plate being positioned so that the second movable contact opposes the third and fourth contacts. The second movable contact is moved by the electromagnet unit to make and break contact with the third and fourth stationary contacts alternately.

Accordingly, the arcing generated between the first and second stationary contacts and between the third and fourth stationary contacts is extinguished effectively.

In one or more embodiments of the invention, the concaved portion has a longitudinal groove define in the base between a first pair of the first and second stationary contact terminals and a second pair of the third and fourth stationary contact terminals.

Accordingly, the arcing generated between each pair of stationary contacts is extinguished effectively by the existence of the longitudinal groove.

In one or more embodiments of the invention, the concaved portion has a longitudinal groove between the permanent magnet and the first stationary contact and/or between the permanent magnet and the second stationary contact.

Accordingly, the arcing generated between the contacts is effectively extended toward the base by the permanent magnet and then extinguished.

In one or more embodiments of the invention, the electromagnetic relay comprises an insulating cover which covers a part of the permanent magnet.

Accordingly, the permanent magnet is protected from heat from the arcing and, as a result, from its deterioration by heat.

In one or more embodiments of the invention, the insulating cover has taper surface portions formed at lower ends of surfaces opposing the first to fourth stationary contact terminals.

Accordingly, the arcing generated from the stationary contact is extended and guided along the taper surface portions toward the base. In particular, the existence of the longitudinal concaved portion below the taper surface portions will help the arcing to be pulled in the longitudinal concaved portion and thereby extinguished effectively.

### BRIEF DESCRIPTION OF THE DRAWINGS

FIGS. 1A and 1B are perspective views showing an electromagnetic relay according to a first embodiment of the present invention as seen at different angles;

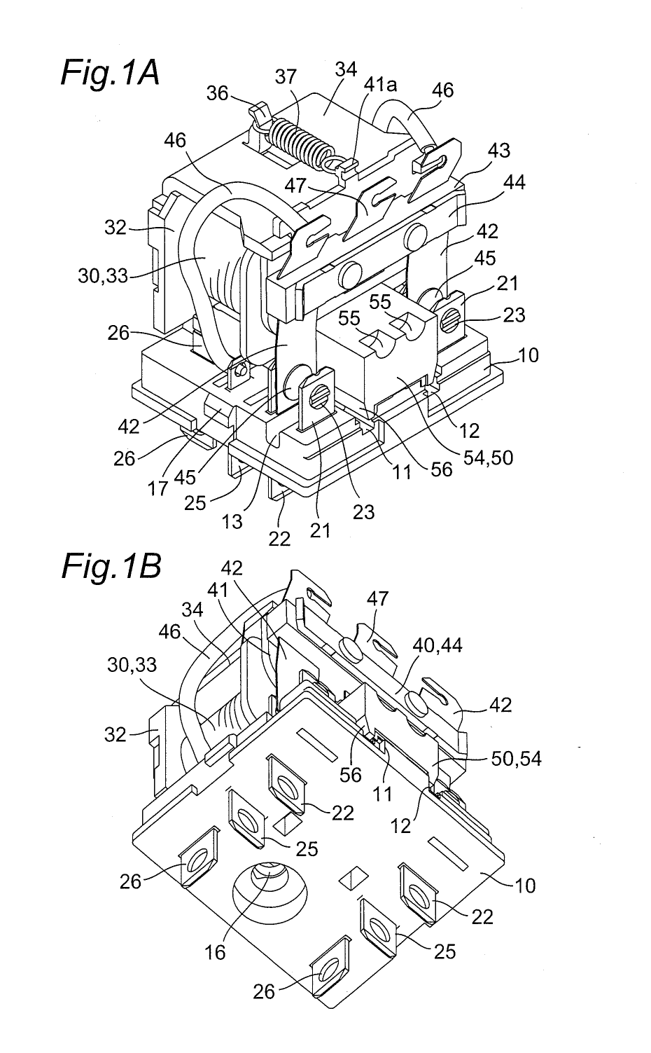

FIG. 2 is an exploded perspective view showing the electromagnetic relay illustrated in FIG. 1A;

FIG. 3 is an exploded perspective view showing the electromagnetic relay illustrated in FIG. 1B;

FIGS. 4A and 4B are a side view and a sectional side view showing the electromagnetic relay illustrated in FIGS. 1A and 1B, respectively;

FIGS. 5A and 5B are a front view and a sectional front view showing the electromagnetic relay illustrated in FIGS. 1A and 1B, respectively;

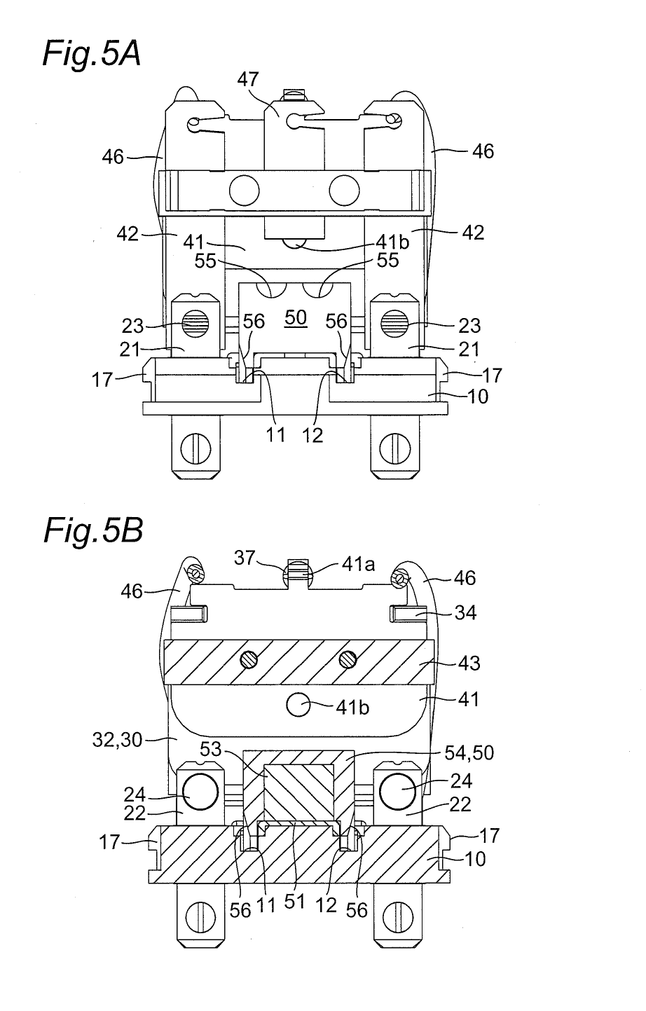

FIGS. 6A and 6B are a partial front view and a partial enlarged perspective view for explaining an arc disappearing method of the electromagnetic relay according to one or more embodiments of the present invention;

FIGS. 7A and 7B are perspective views showing an electromagnetic relay according to a second embodiment of the present invention as seen at different angles;

FIGS. 8A and 8B are a side view and a sectional side view showing the electromagnetic relay illustrated in FIGS. 7A and 7B, respectively; and

FIGS. 9A and 9B are a front view and a sectional front view showing the electromagnetic relay illustrated in FIGS. 7A and 7B, respectively.

### DETAILED DESCRIPTION

Referring to the drawings, embodiments of the invention will be described. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

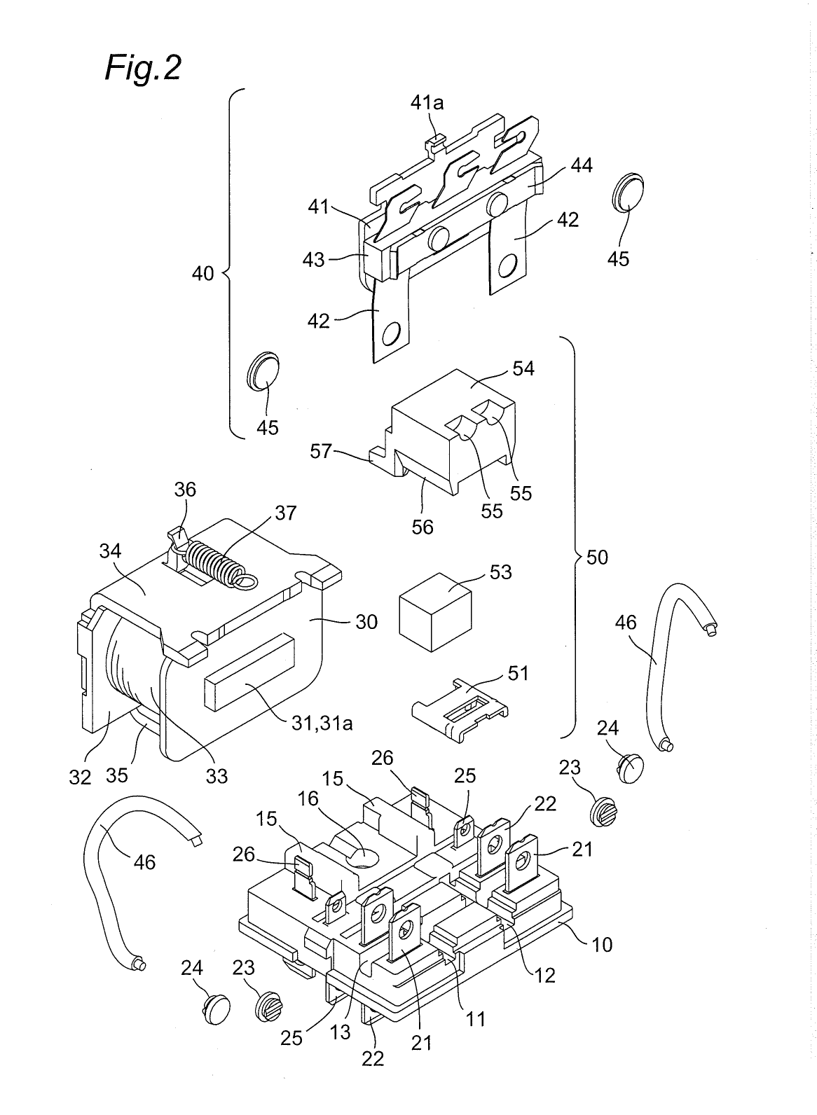

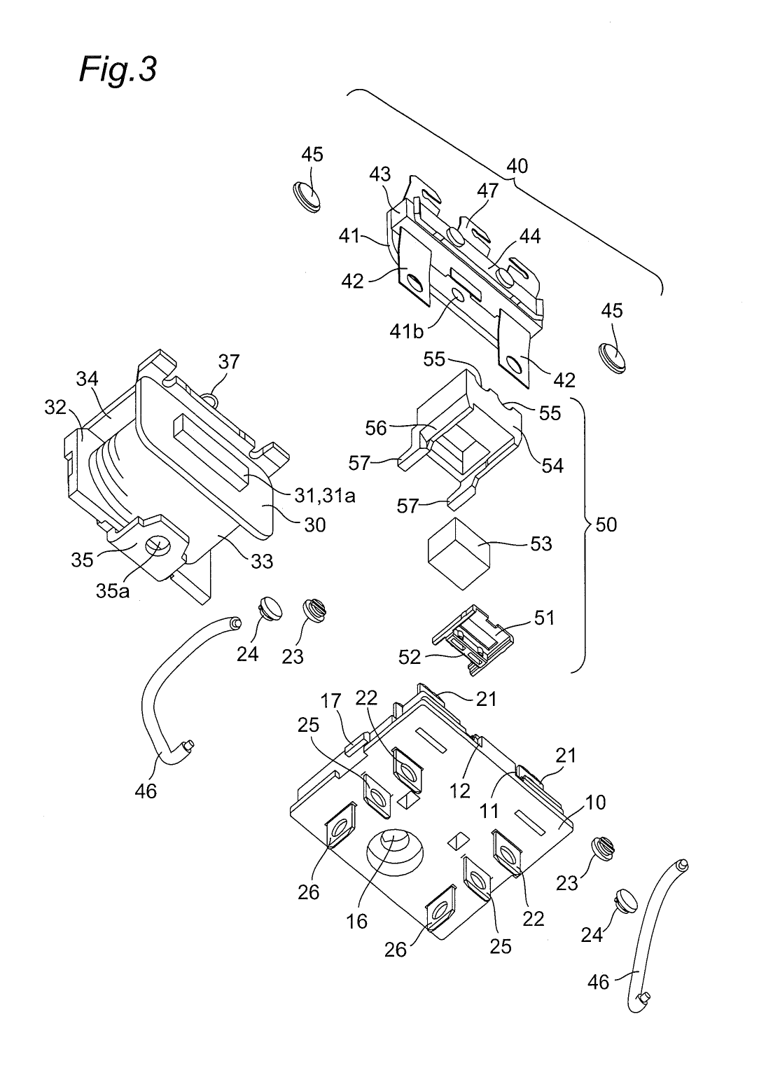

As shown in FIGS. 2 and 3, an electromagnetic relay according to a first embodiment of the invention has a base 10, an electromagnet unit 30, a movable contact unit 40, and a permanent magnet unit 50.

As shown in FIG. 2, the base 10, which is a rectangular resin molded member, supports two sets of contact terminals vertically implanted at neighborhood corners thereof, each contact set having a normally closed stationary contact terminal 21 and a normally opened stationary contact terminal 22. The normally closed stationary contact terminal 21 and the normally opened stationary contact terminal 22 support normally closed stationary contact 22 and normally opened contact 24 fixed thereon, respectively. The upper surface of the base 10 has a transverse concaved portion or groove 13 formed between the normally closed stationary contact terminal 21 and the normally opened stationary contact terminal 22 and two longitudinal concaved portions or grooves 11 and 12 formed inward of and adjacent the normally closed and opened stationary contact terminals 21 and 22 and extending across the transverse groove 13. The base 10 has insertion holes 14 (not indicated in the drawings) defined therein to communicate with the inward ends of the longitudinal grooves 11 and 12. The base 10 also supports two coil terminals 26 vertically implanted at the remaining neighborhood corners thereof and has a pair of positioning projections 15 integrally formed therewith between and adjacent the coil terminals 26. The base 10 also has a threaded hole 16 defined between the positioning projections 15. The base 10 furthermore has a pair of engaging projections 17 formed in opposing side surfaces thereof.

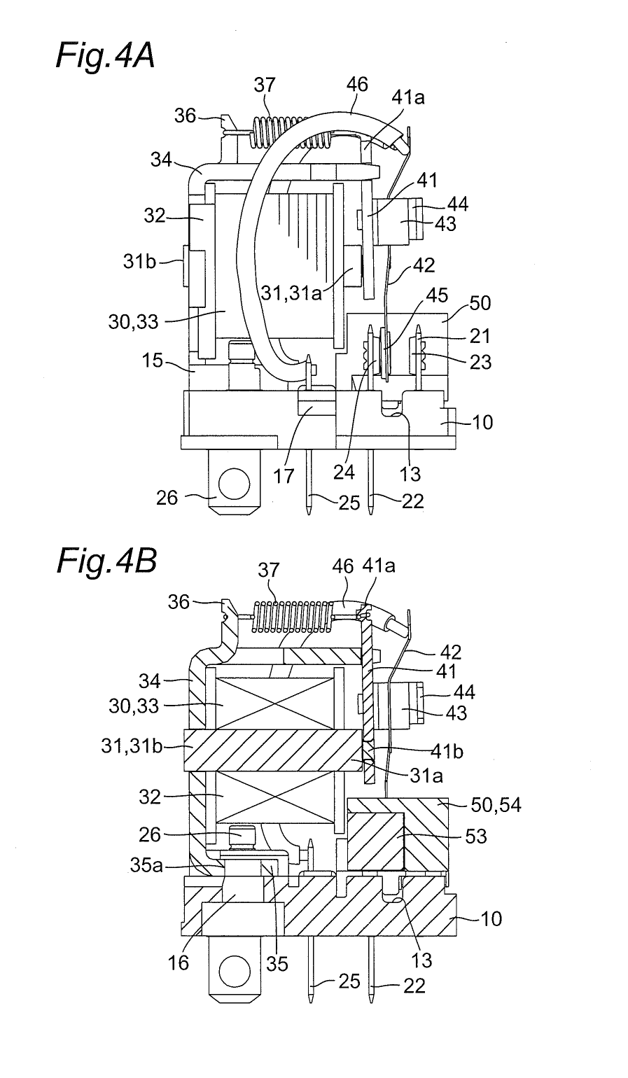

As shown in FIG. 2, the electromagnet unit 30 has a spool 32, a rectangular iron core 31 inserted in the spool 32 with opposite ends thereof projected to form opposite magnetic pole portions 31a and 31b (FIG. 4B), a coil 33 wound around the spool 32, and an L-shaped yoke 34 fixed on one magnetic pole portion 31b. The lower end of the yoke 34 terminates at a mounting tongue 35 having a threaded hole 35a formed therein. The upper horizontal portion of the yoke 34 has an engaging nail 36 formed therewith for supporting one end of a return spring 37.

The electromagnet unit 30 is mounted on the base 10 with the mounting tongue 35 positioned between the positioning projections 15 and fixed on the base 10 by a screw (not shown) threaded in the threaded hole 16. The opposite ends of the coil 33 are wound around the winding portions 26a of the coil terminals 26 and then soldered thereto.

The movable contact unit 40, which has an insulating block 43 and a pair of movable contact plates 42 insert-molded in the insulating block 43, is fixed by using a fixing plate 44 on a movable iron plate 41 which is pivotally connected to a horizontal, distal end of the yoke 34. The movable iron plate 41 has a magnetic shield member 41b mounted on a portion thereof which is attracted to a magnetic pole portion 31a of the iron core 31. The movable iron plate 41 has an engaging nail 41a extending upwardly from an upper edge thereof, with which the other end of the return spring 37 is engaged. The movable contact plates 42 are connected to movable contact terminals 25 through lead wires 46 electrically connected to the upper ends of the movable contact plates 42. A dummy, movable contact plate 47 is provided.

The permanent magnet unit 50 has a positioning plate 51 which is press-fitted on the base 10, a permanent magnet 53 positioned on the positioning plate 51, and an insulating cover 54 which is press-fitted on the positioning plate 51 to cover the permanent magnet 53. The positioning plate 51 is secured on the base 10 by positioning its inserting portion 52 (FIG. 3) in the transverse groove 13 crossing the longitudinal grooves 11 and 12. The base 10 may take different configurations as needed.

The insulating cover 54, which serves to protect the permanent magnet 53 and fix it in position, has a pair of engaging concaved portions 55 formed on an upper edge thereof and taper surface portions 56 formed at opposite, side-surface lower edges thereof. The engaging concaved portions 55 are configured to engage associated engaging convex portions formed in the inner side surfaces of the case (not shown) for the positioning of the insulating cover 54. The insulating cover 54 has a pair of legs 57 extending horizontally from the lower end of an inward facing surface thereof. The insulating cover 54 with the permanent magnet 53 assembled therein is mounted on the base 10 with the legs 57 positioned along and in the paired longitudinal grooves 11 and 12 and also inserted in the insertion holes 14. This results in an appropriate positioning of the permanent magnet 53 against the positioning plate 51. In this condition, the taper surface portions 56 are positioned within the upper portions of the longitudinal grooves 11 and 12.

Next, an operation of the electromagnetic relay will be described. When no voltage is applied to the coil 33 of the electromagnet unit 30, the movable iron plate 41 is forced by the return spring 37, which retains the movable contact 45 of the movable contact plate 42 in pressure contact with the normally closed stationary contact 23.

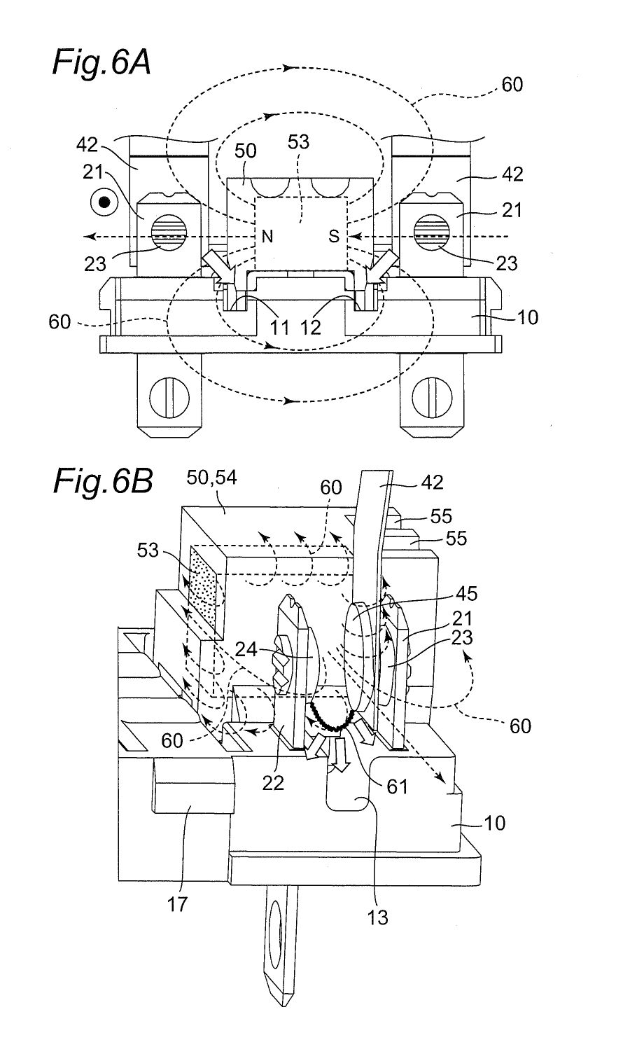

As shown in FIG. 6A, the permanent magnet 53 is positioned so that north and south poles appear on the left and right sides. This results in that, the magnetic field lines 60 of the permanent magnet 53 appear as shown in FIG. 6B. Also, the electric current is applied to flow in a direction from the back surface toward the front surface of the drawing through the normally opened stationary contact 24, the movable contact 45, and then the normally closed stationary contact 23.

When a voltage is applied to the coil 33, the movable iron plate 41 is attracted to the magnetic pole portion 31a of the iron core 31 to move the iron plate 41 against the force from the return spring 37, moving the movable contact 45 away from the normally closed stationary contact 23 and then into contact with the normally opened stationary contact 24, which causes the shield member 41b of the movable iron plate 41 to be attracted to the magnetic pole portion 31a.

When the application of the voltage to the coil 33 is halted, the movable iron plate 41 is moved by the force of the return spring 37 in the opposite direction, which causes that the movable contact 45 is moved away from the normally opened stationary contact 24 and then into contact with the normally closed stationary contact 23. This results in that, as shown in FIGS. 6A and 6B, arcing 61 which may be generated between the normally opened stationary contact 24 and the movable contact 45 is pulled and extended toward the top surface of the base 10 according to Fleming's left-hand rule. In particular, the transverse groove 13 and longitudinal grooves 11 and 12 on the base 10 are formed at respective positions adjacent to where the arcing is expected to generate and, therefore, the generated arcing 61 is pulled and extended largely and thereby extinguished effectively.

Also, an enlargement of the bottom width of the longitudinal grooves 11 and 12 than the opening width thereof allows the arcing to reach the widened bottom surface, which extinguishes the arcing in a reliable manner.

Further, the insulating cover 54 has at its opposite, side-surface lower ends taper surface portions 56 capable of guiding the generated arcing 61 into the longitudinal grooves 11 and 12, and the groove widths at the bottoms of the longitudinal grooves 11 and 12 are greater than top groove widths defined between the taper surface portions 56 and the opposing wall portions of the grooves 11 and 12, which allows the arcing 61 to be pulled and extended toward the bottom surfaces of the longitudinal grooves 11 and 12 and thereby extinguished in a reliable manner. In particular, the arcing is extended along the taper surface portions 56 toward the bottom surfaces of the longitudinal grooves 11 and 12, the insulating cover 54 does not hinder the extinguishing of the arcing 61.

Although in one or more of the previous embodiments, the north and south poles of the permanent magnet 53 are positioned on the left and right in the drawing and the electric current flows through the normally opened stationary contact 24, the movable contact 45, and then the normally closed stationary contact 23 in a direction from the back surface toward the front surface of the drawing, they may be arranged in the opposite directions and the electric current may flow in the opposite direction; namely, the south and north poles of the permanent magnet 53 are positioned on the left and right in the drawing and the electric current flows through the normally closed stationary contact 23, the movable contact 45, and then the normally opened stationary contact 24 in a direction from the front surface toward the back surface of the drawing, and, in this arrangement, similar advantages are obtained.

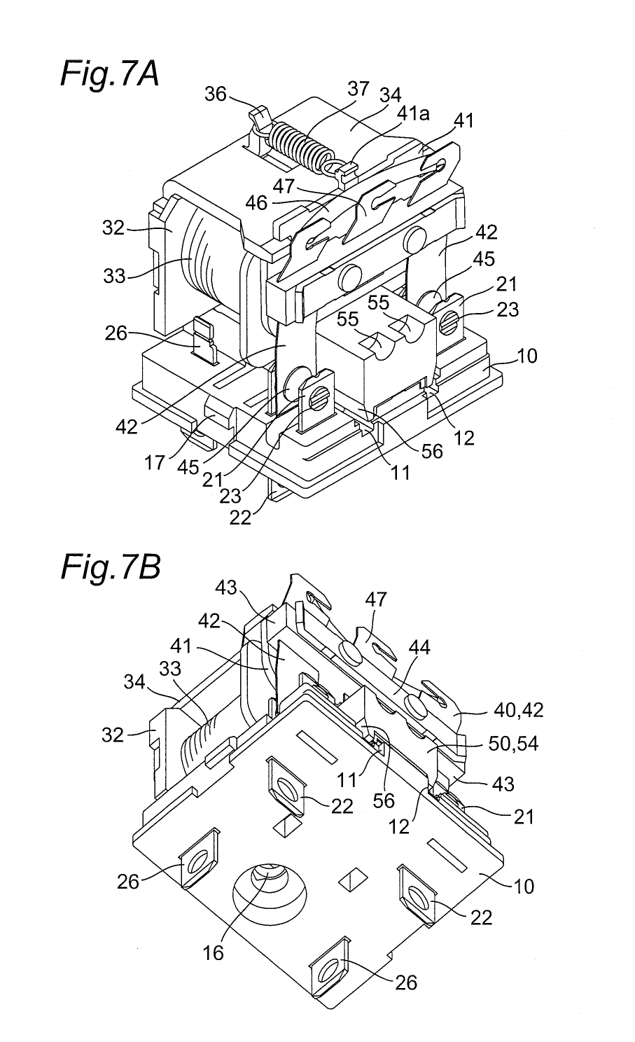

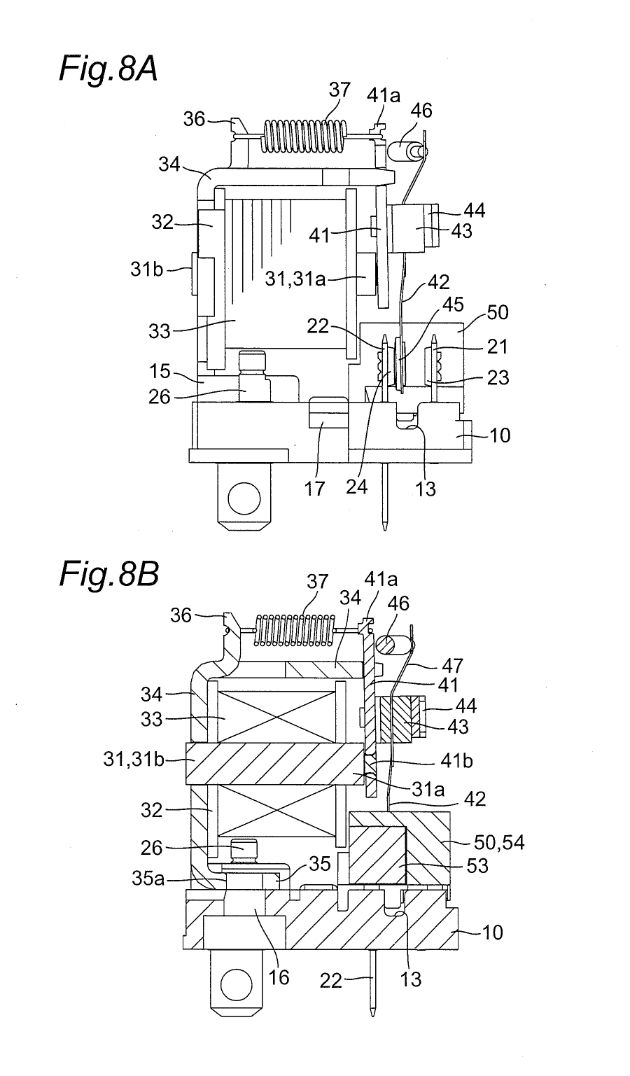

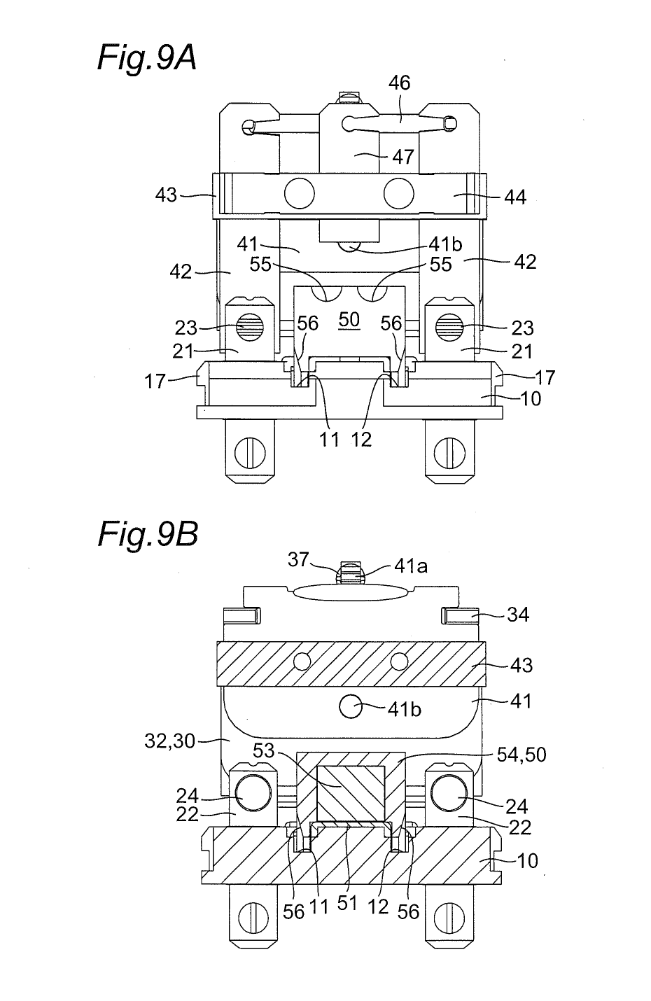

As shown in FIGS. 7A to 9B, a second embodiment of the invention is similar to the first embodiment except that the lead wire 46 is electrically connected to the upper portion of the movable contact plates 42. This causes that the normally closed and opened stationary contacts 23 and 24 are connected in series so that the electric current flows from the normally opened stationary contact 24 to the normally closed stationary contact 23 to generate a certain electromagnetic effect according to the Fleming's left-hand rule. Because other structures are substantially the same as the corresponding structures of the first embodiment, like parts are designated by like reference numerals and duplicate descriptions are eliminated.

According to the second embodiment, the design flexibility of the relay is enhanced.

Although one or more of the previous embodiments has normally closed and opened stationary contacts 23 and 24, one or more embodiments of the invention can have only one of two contacts included in the relay.

Also, the transverse groove 13 and the longitudinal grooves 11 and 12 may be replaced by a through hole or slot.

The invention is not limited to that described above, and the invention can be applied to various electromagnetic relays.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

### PARTS LIST

10: base
11, 12: longitudinal groove
13: transverse groove
14: insertion hole
15: positioning projection
16: threaded hole
21: normally closed stationary contact terminal
22: normally opened contact terminal
23: normally closed stationary contact
24: normally opened stationary contact
25: movable contact terminal
30: electromagnet unit
31: iron core
32: spool
33: coil
40: movable contact unit
41: movable iron plate
42: movable contact plate
45: movable contact
46: lead wire
50: permanent magnet unit
51: positioning plate
52: inserting portion
53: permanent magnet
54: insulating cover
56: taper surface portion
57: leg
60: magnetic force line
61: arcing

1.-11. (canceled)

12. An electromagnetic relay, comprising:
a base;
a first stationary contact terminal mounted on the base, and comprising a first stationary contact mounted thereon;
a first movable contact plate comprising a first movable contact mounted thereon;
an electromagnet unit mounted on the base that moves the first movable contact plate to make or break a contact between the first stationary contact and the first movable contact; and
a permanent magnet mounted on the base so as to extend an arcing generated between the first stationary contact and the first movable contact toward the base.

13. The electromagnetic relay according to claim 12, wherein the base has a concaved portion provided at a portion toward which the arcing is extended.

14. The electromagnetic relay according to claim 13, wherein the concaved portion has a groove having a bottom surface and an opening, the bottom surface having a width that is greater than a width of the opening.

15. The electromagnetic relay according to claim 13, wherein the concaved portion has a slot extending through the base.

16. The electromagnetic relay according to claim 12, further comprising:
a second stationary contact terminal comprising a second stationary contact mounted thereon,
wherein the second stationary contact terminal is positioned so that the first and second stationary contacts oppose to each other through the first movable contact, allowing the first movable contact to make and break contact with the first and second stationary contacts alternately.

17. The electromagnetic relay according to claim 16, wherein the concaved portion has at least one transverse groove defined therein between the first and second stationary contact terminals.

18. The electromagnetic relay according to claim 16, further comprising
a third stationary contact terminal comprising a third stationary contact mounted thereon;
fourth stationary contact terminal comprising a fourth stationary contact mounted thereon, and positioned so that the fourth stationary contact opposes the third stationary contact; and
a second movable contact plate comprising a second movable contact mounted thereon,
wherein the second movable contact plate is positioned so that the second movable contact opposes the third and fourth contacts, and
wherein the second movable contact is moved by the electromagnet unit to make and break contact with the third and fourth stationary contacts alternately.

19. The electromagnetic relay according to claim 16, wherein the concaved portion has a longitudinal groove define in the base between a first pair of the first and second stationary contact terminals and a second pair of the third and fourth stationary contact terminals.

20. The electromagnetic relay according to claim 12, wherein the concaved portion has a longitudinal groove between the permanent magnet and the first stationary contact and/or between the permanent magnet and the second stationary contact.

21. The electromagnetic relay according to claim 12, further comprising an insulating cover which covers a part of the permanent magnet.

22. The electromagnetic relay according to claim 16, further comprising an insulating cover which covers a part of the permanent magnet.

23. The electromagnetic relay according to claim 21, wherein the insulating cover has taper surface portions formed at lower ends of surfaces opposing the first to fourth stationary contact terminals.

24. The electromagnetic relay according to claim 22, wherein the insulating cover has taper surface portions formed at lower ends of surfaces opposing the first to fourth stationary contact terminals.
